(19) United States
(12) Patent Application Publication
(10) Pub. No.: US 2024/0240856 A1
(43) Pub. Date: Jul. 18, 2024

(54) PROCESS AND APPARATUS FOR SEPARATING A MIXTURE OF HYDROGEN AND CARBON DIOXIDE

(71) Applicant: L'Air Liquide, Societe Anonyme pour l'Etude et l’Exploitation des Procedes Georges Claude, Paris (FR)

(72) Inventors: Felix PERE, Champigny-Sur-Marne (FR); Mathieu LECLERC, Champigny-Sur-Marne (FR)

(73) Assignee: L'Air Liquide, Societe Anonyme pour l'Etude et l’Exploitation des Procedes Georges Claude, Paris (FR)

(21) Appl. No.: 18/411,328

(22) Filed: Jan. 12, 2024

(30) Foreign Application Priority Data
Jan. 12, 2023 (FR) FR 2300297

(51) Int. Cl. F25J 3/04; F25J 3/02

(52) U.S. Cl. CPC F25J 3/04636; F25J 3/0252; F25J 3/0266; F25J 2220/82; F25J 2245/02

(57) ABSTRACT

In a process for separating a mixture containing hydrogen and carbon dioxide, the following steps are present: a) cooling of the mixture in a heat exchanger by sending the mixture to the heat exchanger, resulting in the partial condensation of the mixture into a liquid phase enriched in carbon dioxide and a gas phase depleted in carbon dioxide, a gaseous fluid which is heated in the heat exchanger by indirect heat exchange, b) separating the liquid phase from the gas phase in a separator vessel, c) heating of the gas phase originating from at least one of the separator vessels in the heat exchanger, d) sending of the at least one heated part from step c) to a membrane separation unit, generating a residue depleted in hydrogen and carbon dioxide and e) expansion of the at least one residue in a turbine producing an expanded fluid, f) the expanded fluid constituting the gaseous fluid of step a) which is heated in the heat exchanger by indirect heat exchange.

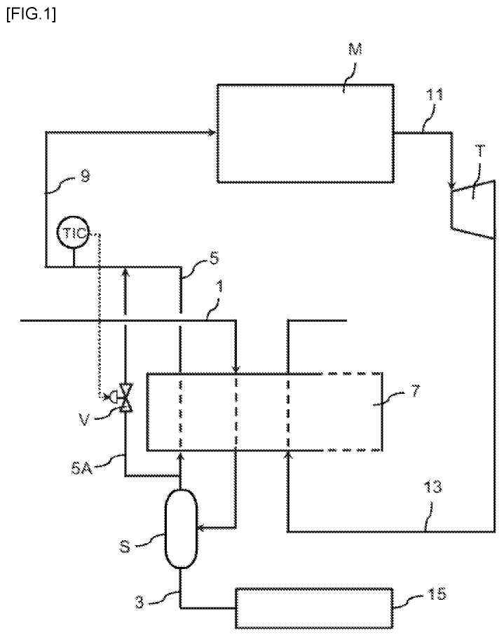

### CROSS REFERENCE TO RELATED APPLICATIONS

This application claims the benefit of priority under 35 U.S.C. § 119 (a) and (b) to French patent application No. FR2300297, filed Jan. 12, 2023, which is herein incorporated by reference in its entirety.

### FIELD OF THE INVENTION

The present invention relates to a process and apparatus for separating a mixture of hydrogen and carbon dioxide, in particular a mixture also comprising at least one other component, such as carbon monoxide, methane or nitrogen. The mixture may optionally comprise water.

### BACKGROUND OF THE INVENTION

It has a particular advantage for such processes in which the mixture to be separated has previously been separated by adsorption, for example in H₂ PSA, to produce a gas enriched in hydrogen and depleted in carbon dioxide and this mixture in gaseous form which is depleted in hydrogen and enriched in carbon dioxide with respect to the gas treated in the adsorption.

For such processes equipped with turbines, the invention makes it possible to reduce the load of the separation process in a stable and efficient manner.

The adsorption process that produces the mixture to be separated often treats a gas from a hydrogen production process, for example a reforming process such as a steam methane reformer known under the acronym SMR, an autothermal reformer known under the acronym ATR, or a partial oxidation known under the acronym POX.

FR2877939 describes the separation of a waste gas from a PSA by partial condensation, the non-condensables of the partial condensation being separated by permeation, the permeate being recycled upstream of the PSA and the residue is sent to the reforming as feedstock and fuel.

WO2012/064938, WO2012/064941 and WO2012/158673 describe the separation, by permeation, of a flow of non-condensables from a low-temperature CO2 separation, involving the turbine expansion of a residue and the compression of a permeate.

US2011/0138852 describes processes in which a mixture is separated by permeation, the permeate enriched in CO2 is separated by partial condensation and the residue is expanded in a turbine.

### SUMMARY OF THE INVENTION

In certain embodiments of the invention, the process treats a gas, which may be the hydrogen-depleted waste gas from an adsorption process, for example of pressure swing type, known under the acronym PSA. This gas can be compressed, dried, separated by partial condensation and/or distillation to produce a fluid enriched in CO2, a waste gas of the partial condensation and/or the distillation being separated by permeation in two membrane units.

The core of the process according to the invention is to combine:
A first low-temperature separation (below)−40° C. by partial condensation and optionally by distillation, which makes it possible to recover and to purify a percentage of the CO₂ contained in the treated feedstock, for example having a yield of at least 60%,
A second step of membrane treatment applied to at least one non-condensable part of the low-temperature part, the membrane treatment producing, for example:
   A fluid rich in hydrogen recycled to the upstream production unit, for example the reforming unit, in order to increase its production or reduce its load in order to produce the same amount of hydrogen, and/or
   A fluid of intermediate composition, rich in H₂ and CO₂, recycled to the section operating at low temperature in order to recover the CO₂ therefrom and/or
   A fluid low in H₂ and CO₂, returned to the hydrogen production unit, typically to be utilized as fuel.

It is possible to increase the performance levels of the membrane separation by incorporating therein at least one turbine utilizing the pressure energy of the residue of the membranes.

According to one subject of the invention, what is provided is a process for separating a mixture containing hydrogen and carbon dioxide, as well as at least one compound lighter than carbon dioxide chosen from the list: carbon monoxide, methane, nitrogen, comprising the following steps:
a) cooling of the mixture from a first temperature in a heat exchanger by sending the mixture to the heat exchanger, resulting in the partial condensation of the mixture into a liquid phase enriched in carbon dioxide and a gas phase depleted in carbon dioxide, the mixture exiting the heat exchanger at a second temperature lower than the first temperature, said heat exchanger being at least partially cooled by a gaseous fluid which is heated in the heat exchanger by indirect heat exchange;
b) separation of the liquid phase from the gas phase in one or more separator vessels, optionally in several steps interspersed with successive cooling phases;
c) heating of at least one part of the gas phase originating from at least one of the separator vessels in the heat exchanger by indirect heat exchange;
d) sending of the at least one heated part from step c) to a membrane separation unit as the sole feed flow of the membrane separation unit, and generating one or more permeates enriched in hydrogen and/or carbon dioxide and depleted in the at least one component lighter than carbon dioxide with respect to the heated part, and at least one residue depleted in hydrogen and carbon dioxide and enriched in the at least one component lighter than carbon dioxide with respect to the heated part;
e) the expansion of the at least one residue from a first pressure in one or more turbines producing a fluid expanded to a second pressure lower than the first pressure and to a third temperature lower than the first temperature and preferably to the second temperature or lower than the second temperature; and
f) the fluid at the second pressure produced in step e) constituting the gaseous fluid of step a) which is heated in the heat exchanger by indirect heat exchange with the mixture.
   According to other optional aspects:
the first temperature is greater than 0° C., indeed even greater than 10° C.;
the second temperature is less than 0° C., preferably less than −30° C., indeed even less than −40° C.;
the membrane separation unit operates at a temperature greater than 50° C. and the at least one heated part from step c) is heated downstream of the heat exchanger and upstream of the membrane separation unit in an auxiliary heat exchanger;
the fluid expanded to the second pressure is sent to the heat exchanger without passing through the auxiliary heat exchanger;
one part of the gas phase produced in the at least one separator vessel is heated in the heat exchanger and another part of the gas phase produced in the at least one separator vessel is not heated in the heat exchanger, the two parts being mixed downstream of the heat exchanger, the ratio between the flow rates of the two parts being regulated in order to reach a target temperature after mixture of the two parts;
the mixture of the two parts is sent to the membrane separation unit;
the mixture containing hydrogen and carbon dioxide is a waste gas from a process for separation by adsorption, for example by pressure swing adsorption;
step b), optionally followed by a distillation step, produces a fluid containing at least 60 mol % of carbon dioxide, preferably at least 80 mol % of carbon dioxide, indeed even at least 90 mol % of carbon dioxide;
the membrane separation unit produces a fluid enriched in hydrogen which is recycled to the upstream adsorption process in order to increase its production or to reduce its load in order to produce the same amount of hydrogen and/or a fluid of intermediate composition, enriched in H₂ and CO₂, separated in at least one of the separator vessels and/or by the distillation in order to recover the CO₂ therefrom and/or a fluid depleted in H₂ and CO₂, returned to a hydrogen production unit, feeding the adsorption process, typically to be utilized as fuel;
no part of the permeate or permeates is sent to the separation of step b);
the residue is sent to the turbine without being passed through a combustion chamber; and/or
the at least one part of the phase is not cooled in the heat exchanger upstream of the membrane separation unit.

According to another subject of the invention, what is provided is an apparatus for separating a mixture containing hydrogen and carbon dioxide, as well as at least one compound lighter than carbon dioxide chosen from the list: carbon monoxide, methane, nitrogen, comprising a heat exchanger having a cold end and a hot end, the cold end being suitable for operating at a temperature colder than the hot end, means for sending a mixture to be cooled from a first temperature in the heat exchanger by sending the mixture to the heat exchanger, resulting in the partial condensation of the mixture into a liquid phase enriched in carbon dioxide and a gas phase depleted in carbon dioxide, means for removing the mixture from the heat exchanger at a second temperature lower than the first temperature, means for sending a gaseous fluid which is heated in the heat exchanger by indirect heat exchange with the mixture, a partial condensation unit comprising one or more separator vessels connected in series or in parallel to separate a liquid phase from a gas phase of the mixture exiting the exchanger, means for sending at least one part of the gas phase originating from at least one of the separator vessels into the heat exchanger to be heated by indirect heat exchange, a membrane separation unit, means for sending the at least one heated part of the gas phase to the membrane separation unit, means for removing one or more permeates enriched in hydrogen and/or carbon dioxide and depleted in the at least one compound lighter than carbon dioxide from the membrane separation unit, means for removing at least one residue depleted in hydrogen and carbon dioxide and enriched in the at least one compound lighter than carbon dioxide from the membrane separation unit, at least one turbine, means for sending at least one part of the at least one residue to be expanded from a first pressure in the turbine or turbines, without being passed through the heat exchanger, producing a fluid expanded to a second pressure lower than the first pressure at a third temperature lower than the first temperature and preferably than the second temperature and means for sending the fluid at the second pressure to the heat exchanger to be heated as the gaseous fluid which is heated in the heat exchanger by indirect heat exchange, characterized in that the separator vessel or vessels connected in series or in parallel is/are directly connected to the heat exchanger without passing through the membrane separation unit and the means for sending the fluid at the second pressure to the heat exchanger are connected so as to introduce the fluid at the second pressure into the heat exchanger at its cold end.

Preferably, the means for sending a mixture to be cooled from a first temperature in the heat exchanger are connected to the hot end of the heat exchanger.

The apparatus may comprise means for sending one part of the gas phase to the membrane separation unit without passing through the heat exchanger.

According to one subject of the invention, what is provided is a process for separating a mixture containing hydrogen and carbon dioxide, as well as at least one compound lighter than carbon dioxide chosen from the list: carbon monoxide, methane, nitrogen, comprising the following steps:
a) cooling of the mixture from a first temperature in a heat exchanger by sending the mixture to the heat exchanger, resulting in the partial condensation of the mixture into a liquid phase enriched in carbon dioxide and a gas phase depleted in carbon dioxide, the mixture exiting the heat exchanger at a second temperature lower than the first temperature, said heat exchanger being at least partially cooled by a gaseous fluid which is heated in the heat exchanger by indirect heat exchange,
b) separation of the liquid phase from the gas phase in one or more separator vessels, optionally in several steps interspersed with successive cooling phases, c) heating of at least one part of the gas phase originating from at least one of the separator vessels in the heat exchanger by indirect heat exchange,
d) sending of the at least one heated part from step c) to a membrane separation unit, generating one or more permeates enriched in hydrogen and/or carbon dioxide and depleted in the at least one component lighter than carbon dioxide, and at least one residue depleted in hydrogen and carbon dioxide and enriched in the at least one component lighter than carbon dioxide, and
e) expansion of the at least one residue from a first pressure in one or more turbines producing a fluid expanded to a second pressure lower than the first pressure at a third temperature lower than the first temperature and preferably than the second temperature,
f) the fluid at the second pressure produced in step e) constituting the gaseous fluid of step a) which is heated in the heat exchanger by indirect heat exchange.

According to other optional aspects:
the first temperature is greater than 0° C., indeed even greater than 10° C.;
the second temperature is less than 0° C., preferably less than −30° C., indeed even less than −40° C.;
the membrane separation unit operates at a temperature greater than 50° C. and the at least one heated part from step c) is heated downstream of the heat exchanger and upstream of the membrane separation unit in an auxiliary heat exchanger;
the fluid expanded to the second pressure is sent to the heat exchanger without passing through the auxiliary heat exchanger;
one part of the gas phase produced in the at least one separator vessel is heated in the heat exchanger and another part of the gas phase produced in the at least one separator vessel is not heated in the heat exchanger, the two parts being mixed downstream of the heat exchanger, the ratio between the flow rates of the two parts being regulated in order to reach a target temperature after mixture of the two parts;
the mixture of the two parts is sent to the membrane separation unit;
the mixture containing hydrogen and carbon dioxide is a waste gas from a process for separation by adsorption, for example by pressure swing adsorption;
step b), optionally followed by a distillation step, produces a fluid containing at least 60 mol % of carbon dioxide, preferably at least 80 mol % of carbon dioxide, indeed even at least 90 mol % of carbon dioxide;
the membrane separation unit produces:
   a fluid enriched in hydrogen which is recycled to the upstream adsorption process in order to increase its production or to reduce its load in order to produce the same amount of hydrogen; and/or
   a fluid of intermediate composition, enriched in H₂ and CO₂, separated in at least one of the separator vessels and/or by the distillation in order to recover the CO₂ therefrom; and/or
   a fluid depleted in H₂ and CO₂, returned to a hydrogen production unit, feeding the adsorption process, typically to be utilized as fuel.

According to another aspect of the invention, what is provided is an apparatus for separating a mixture containing hydrogen and carbon dioxide, as well as at least one compound lighter than carbon dioxide chosen from the list: carbon monoxide, methane, nitrogen, comprising a heat exchanger, means for sending a mixture to be cooled from a first temperature in the heat exchanger by sending the mixture to the heat exchanger, resulting in the partial condensation of the mixture into a liquid phase enriched in carbon dioxide and a gas phase depleted in carbon dioxide, means for removing the mixture from the heat exchanger at a second temperature lower than the first temperature, means for sending a gaseous fluid which is heated in the heat exchanger by indirect heat exchange, a partial condensation unit comprising one or more separator vessels connected in series or in parallel to separate a liquid phase from a gas phase of the mixture exiting the exchanger, means for sending at least one part of the gas phase originating from at least one of the separator vessels into the heat exchanger to be heated by indirect heat exchange, a membrane separation unit, means for sending the at least one heated part of the gas phase to the membrane separation unit, means for removing one or more permeates enriched in hydrogen and/or carbon dioxide and depleted in the at least one compound lighter than carbon dioxide from the membrane separation unit, means for removing at least one residue depleted in hydrogen and carbon dioxide and enriched in the at least one compound lighter than carbon dioxide from the membrane separation unit, at least one turbine, means for sending at least one part of the at least one residue to be expanded from a first pressure in the turbine or turbines producing a fluid expanded to a second pressure lower than the first pressure at a third temperature lower than the first temperature and preferably than the second temperature and means for sending
the fluid at the second pressure to the heat exchanger to be heated as the gaseous fluid which is heated in the heat exchanger by indirect heat exchange.

According to the invention, the cooled gas produced by the expansion by the at least one turbine of a residue from the permeation may be used to cool the mixture to be separated upstream of the low-temperature separation.

According to one version of the invention, this at least one turbine drives at least one compressor brake, fed by a permeate from a membrane separation step, which makes it possible to reduce the permeation pressure.

An advantage of the layout according to this version is the elimination of the recourse to an external heat source for heating non-condensables upstream of the membranes, if the latter operate at a temperature requiring this heating. Specifically, the compression of the permeates results in an increase in temperature, which can be utilized in the upstream multi-fluid exchanger.

By providing more cold to the cryogenic part, the use of a turbine to expand the residue makes it possible to reduce the surface area of the cryogenic exchanger, as well as the energy consumption. This utilization of cold is even obligatory, since the gas is used at the very least at ambient temperature for the regeneration of dryers before it is returned for combustion.

However, this innovation is not without disadvantages. Specifically, the utilization of the compression heat of the boosters comes at the price of numerous control loops, with multiple bypasses redirecting the heat and the cold around the exchanger and machines to stabilize the system. This complex system is even more destabilized by the variations in temperature of the non-condensables from the cryogenic part, ultimately attributable to variations in temperature of the cooling water.

In addition, the use of rotating machines brings about a matter of reliability. In the event of failure or of degraded operation of one of the machines, it is no longer possible to sufficiently cool the fuel gas in order to utilize it in the cryogenic part. The reduced surface area of the exchanger quickly proves to be a hindrance that greatly limits the capacity and the performance levels of the unit.

According to one variant of the invention, it is possible to solve the two problems mentioned above, this being based on the following concept: not utilizing the cold energy provided by the turbine in the cryogenic part as a reduction in the exchange surface area.

More specifically, this proposed variant of the invention consists in not heating all of the non-condensables from the partial condensation in the cryogenic exchanger, and therefore extracting, at cryogenic temperature, an amount of non-condensables corresponding at least to the cold provided by the turbined fluid.

### BRIEF DESCRIPTION OF THE DRAWINGS

Other features and advantages of the invention will become further apparent via, on the one hand, the following description and, on the other hand, several exemplary embodiments given by way of non-limiting indication and with reference to the attached schematic drawings, in which:

The FIGURE describes a separation process according to the invention.

### DETAILED DESCRIPTION OF THE INVENTION

A mixture 1 of the FIGURE containing hydrogen and carbon dioxide, as well as at least one compound lighter than carbon dioxide chosen from the list: carbon monoxide, methane, nitrogen, is at a pressure of at least 5 bar a and a first temperature of greater than 0° C., indeed even greater than 10° C. The mixture 1 may be a hydrogen-depleted waste gas from an adsorption process, for example by pressure swing of PSA type.

The mixture 1 is cooled to a second temperature less than 0° C., preferably less than −30° C., indeed even less than −40° C., and partially condensed in a heat exchanger 7 by travelling through the heat exchanger from one end to the other and the two-phase fluid formed is separated in a phase separator S forming a gas 5 and a liquid 3. The liquid 3 enriched in carbon dioxide is separated in a separation unit 15 at a temperature less than −40° C. by partial condensation and/or by distillation to form a product rich in carbon dioxide. Or else, the liquid 3 may be the product rich in carbon dioxide from the separation.

Here the partial condensation unit comprises only a single phase separator, but it will be understood that the unit may comprise several phase separators S in series or in parallel.

The gas 5 is heated in the heat exchanger 7, by indirect heat exchange with the mixture 1, to a temperature of greater than 0° C. but preferably less than 80° C., indeed even than 50° C. The gas 9, optionally after a heating step, is separated by permeation in a permeation unit M where at least one permeation step occurs which produces at least one permeate 10 enriched in carbon dioxide and in hydrogen with respect to the gas 9 and depleted in the at least one compound lighter than carbon dioxide with respect to the gas 9 and at least one residue 11 depleted in carbon dioxide and in hydrogen with respect to the gas 9 and enriched in the at least one compound lighter than carbon dioxide with respect to the gas 9.

The membrane separation unit M may operate at a temperature greater than 50° C. and the at least one heated part from step c) is heated downstream of the heat exchanger and upstream of the membrane separation unit in an auxiliary heat exchanger (not illustrated).

The residue is expanded in a turbine T or several turbines in series to reduce its pressure and lower its temperature to a temperature of at most −0° C. Without having been heated, the expanded residue 13 is sent to the heat exchanger 7, indeed even the cold end of the heat exchanger 7, where it is heated from a third temperature, lower than the first temperature, indeed even than the second temperature, by travelling through the exchanger, for example from one end to the other, in countercurrent with the mixture 1 by indirect heat exchange therewith.

The expanded and heated flow 13 is low in H₂ and CO2, but may be returned to a hydrogen production unit, feeding the PSA, typically to be utilized as fuel.

If the auxiliary heat exchanger is present, the fluid 13 expanded to the second pressure is sent to the heat exchanger 7 without passing through the auxiliary heat exchanger.

According to this version of the invention, all the gas 5 is sent to be heated in the heat exchanger 7 by travelling through the exchanger from one end to the other, in countercurrent with the mixture 1.

According to another variant, one part 5A of the gas from the separator S is sent through a valve V and is not heated in the heat exchanger 7, or is only partially heated in the heat exchanger 7, then being extracted at an intermediate level of the heat exchanger 7. The two gases, i.e. the heated (or partially heated) gas 5 and the non-heated gas 5A, are mixed downstream of the heat exchanger to form a gas 9 colder than the gas 5. The temperature of the gas 9 is varied by adjusting the relative flow rates of the gases 5, 5A with the valve V.

By intentionally rejecting the cold of the part 5A, the benefits of the expansion in the turbine T in terms of thermal integration are partially lost. However, this has several counterparts:
By not utilizing the additional cold energy as a reduction in the exchange surface area, an exchanger 7 is kept which can optionally dispense with the cold from the turbine T or turbines T in the event of failure. The unit is therefore more robust.
By virtue of this rejection of cold towards the hot end of the section operating at low temperature, it is possible to regulate the temperature of the gas 9 which is returned to the membrane part M. By doing so, it is possible to smooth out the variations in temperatures caused by the variations of the fluid 1 which most often comes from a heat exchanger with an ambient fluid such as cooling water or air. Consequently, the control loops around the turbine T operate at a fixed temperature, and therefore with a lot fewer variations. The system is therefore stabilized and made reliable. This advantage is even more obvious if the membrane separation unit M comprises at least one permeate booster compressor coupled to at least one residue turbine T.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A process for separating a mixture containing hydrogen and carbon dioxide, as well as at least one compound lighter than carbon dioxide chosen from the list: carbon monoxide, methane, nitrogen, comprising the following steps:
a) cooling of the mixture from a first temperature in a heat exchanger by sending the mixture to the heat exchanger, resulting in the partial condensation of the mixture into a liquid phase enriched in carbon dioxide and a gas phase depleted in carbon dioxide, the mixture exiting the heat exchanger at a second temperature lower than the first temperature, said heat exchanger being at least partially cooled by a gaseous fluid which is heated in the heat exchanger by indirect heat exchange;
b) separation of the liquid phase from the gas phase in one or more separator vessels, optionally in several steps interspersed with successive cooling phases;
c) heating of at least one part of the gas phase originating from at least one of the separator vessels in the heat exchanger by indirect heat exchange;
d) sending of the at least one heated part from step c) to a membrane separation unit as the sole feed flow of the membrane separation unit, and generating one or more permeates enriched in hydrogen and/or carbon dioxide and depleted in the at least one component lighter than carbon dioxide with respect to the heated part, and at least one residue depleted in hydrogen and carbon dioxide and enriched in the at least one component lighter than carbon dioxide with respect to the heated part;
e) the expansion of the at least one residue from a first pressure in one or more turbines producing a fluid expanded to a second pressure lower than the first pressure and to a third temperature lower than the first temperature and preferably to the second temperature or lower than the second temperature; and
f) the fluid at the second pressure produced in step e) constituting the gaseous fluid of step a) which is heated in the heat exchanger by indirect heat exchange with the mixture.

2. The process according to claim 1, wherein the first temperature is greater than 0° C.

3. The process according to claim 1, wherein the second temperature is less than 0° C., preferably less than −30° C., indeed even less than −40° C.

4. The process according to claim 1, wherein the membrane separation unit operates at a temperature greater than 50° C. and the at least one heated part from step c) is heated downstream of the heat exchanger and upstream of the membrane separation unit in an auxiliary heat exchanger.

5. The process according to claim 4, wherein the fluid expanded to the second pressure is sent to the heat exchanger without passing through the auxiliary heat exchanger.

6. The process according to claim 1, wherein one part of the gas phase produced in the at least one separator vessel is heated in the heat exchanger and another part of the gas phase produced in the at least one separator vessel is not heated in the heat exchanger, the two parts being mixed downstream of the heat exchanger, the ratio between the flow rates of the two parts being regulated in order to reach a target temperature after mixture of the two parts.

7. The process according to claim 6, wherein the mixture of the two parts is sent to the membrane separation unit.

8. The process according to claim 1, wherein the mixture containing hydrogen and carbon dioxide is a waste gas from a process for separation by adsorption, for example by pressure swing adsorption.

9. The process according to claim 1, wherein step b), optionally followed by a distillation step, produces a fluid containing at least 60 mol % of carbon dioxide, preferably at least 80 mol % of carbon dioxide, indeed even at least 90 mol % of carbon dioxide.

10. The process according to claim 1, wherein the membrane separation unit produces a fluid enriched in hydrogen which is recycled to the upstream adsorption process in order to increase its production or to reduce its load in order to produce the same amount of hydrogen and/or a fluid of intermediate composition, enriched in H₂ and CO₂, separated in at least one of the separator vessels and/or by the distillation in order to recover the CO₂ therefrom and/or a fluid depleted in H₂ and CO₂, returned to a hydrogen production unit, feeding the adsorption process, typically to be utilized as fuel.

11. The process according to claim 1, wherein no part of the permeate or permeates is sent to the separation of step b).

12. The process according to claim 1, wherein the residue is sent to the turbine without being passed through a combustion chamber.

13. The process according to claim 1, wherein the at least one part of the phase is not cooled in the heat exchanger upstream of the membrane separation unit.

14. An apparatus for separating a mixture containing hydrogen and carbon dioxide, as well as at least one compound lighter than carbon dioxide chosen from the list: carbon monoxide, methane, and nitrogen, the apparatus comprising:
a heat exchanger having a cold end and a hot end, the cold end being configured for operating at a temperature colder than the hot end;
means for sending a mixture to be cooled from a first temperature in the heat exchanger by sending the mixture to the heat exchanger, resulting in the partial condensation of the mixture into a liquid phase enriched in carbon dioxide and a gas phase depleted in carbon dioxide;
means for removing the mixture from the heat exchanger at a second temperature lower than the first temperature;
means for sending a gaseous fluid which is heated in the heat exchanger by indirect heat exchange with the mixture;
a partial condensation unit comprising one or more separator vessels connected in series or in parallel to separate a liquid phase from a gas phase of the mixture exiting the exchanger;
means for sending at least one part of the gas phase originating from at least one of the separator vessels into the heat exchanger to be heated by indirect heat exchange;
a membrane separation unit, means for sending the at least one heated part of the gas phase to the membrane separation unit;
means for removing one or more permeates enriched in hydrogen and/or carbon dioxide and depleted in the at least one compound lighter than carbon dioxide from the membrane separation unit;
means for removing at least one residue depleted in hydrogen and carbon dioxide and enriched in the at least one compound lighter than carbon dioxide from the membrane separation unit;
at least one turbine, means for sending at least one part of the at least one residue to be expanded from a first pressure in the turbine or turbines, without being passed through the heat exchanger, producing a fluid expanded to a second pressure lower than the first pressure at a third temperature lower than the first temperature; and
means for sending the fluid at the second pressure to the heat exchanger to be heated as the gaseous fluid which is heated in the heat exchanger by indirect heat exchange,
wherein the separator vessel or vessels connected in series or in parallel is/are directly connected to the heat exchanger without passing through the membrane separation unit and the means for sending the fluid at the second pressure to the heat exchanger are connected so as to introduce the fluid at the second pressure into the heat exchanger at its cold end.

15. The apparatus according to claim 14, further comprising means for sending one part of the gas phase to the membrane separation unit without passing through the heat exchanger.
